(19) United States
(12) Patent Application Publication
(10) Pub. No.: US 2016/0210891 A1
(43) Pub. Date: Jul. 21, 2016

(54) LIQUID CRYSTAL DISPLAY DEVICE, AND IMAGE DISPLAY METHOD FOR LIQUID CRYSTAL DISPLAY DEVICE

(71) Applicant: Sharp Kabushiki Kaisha, Osaka (JP)

(72) Inventors: Xiaomang ZHANG, Osaka (JP); Toshihiro YANAGI, Osaka (JP); Takae ITOU, Osaka (JP); Hideki MORII, Osaka (JP); Takayuki MIZUNAGA, Osaka (JP); Keishi NISHIKUBO, Osaka (JP)

(73) Assignee: Sharp Kabushiki Kaisha, Osaka (JP)

(21) Appl. No.: 14/914,236

(22) PCT Filed: Jul. 17, 2014
(86) PCT No.: PCT/JP2014/068986

§ 371 Date: Feb. 24, 2016

(30) Foreign Application Priority Data
Aug. 28, 2013 (JP) 2013-176915

(51) Int. Cl. G09G 3/20; G09G 3/36

(52) U.S. Cl. CPC G09G 3/2003; G09G 3/36; G09G 2320/0233; G09G 2320/0276; G09G 2320/0666; G09G 2320/0673

(57) ABSTRACT

A liquid crystal display device capable of reproducing colors faithfully is provided. The liquid crystal display device includes a color gamut conversion unit that generates an RGB signal for a liquid crystal panel (RGBₒᵤₜ), which is provided to a liquid crystal panel, by converting data values of respective colors included in an input RGB signal (RGBᵢₙ) in accordance with the color gamut of the input RGB signal (RGBᵢₙ) and the color gamut of the liquid crystal panel. When the color gamut of the input RGB signal (RGBᵢₙ) is included within the color gamut of the liquid crystal panel, colors represented by the input RGB signal (RGBᵢₙ) are faithfully reproduced on the liquid crystal panel by providing the RGB signal for liquid crystal panel generated by the color gamut conversion unit to the liquid crystal panel.

### TECHNICAL FIELD

The present invention relates to a liquid crystal display device and an image display method of the liquid crystal display device, and in particular, to a color reproduction technology using a color gamut conversion process of the liquid crystal display device.

### BACKGROUND ART

In recent years, increase in the resolution of display devices such as liquid crystal display devices has become prominent. Improvement in the color reproduction capability of display devices has also become prominent. Today, the NTSC ratio is used as an indicator that expresses the color reproduction capability of a display device, and a display device with a NTSC ratio of about 150% has been achieved. However, a color gamut (also called “color reproduction range” or the like) among devices such as a display device, a printing device, or an imaging device generally differs. Also, in a color television device, the color gamut of the input image signal differs among the television standards being used, for example. For these reasons, in order to output colors that are as faithful to the input data as possible regardless of differences in the color gamut, performing various types of conversion processes on the input data has been proposed. In the present specification, a process in which the input signal values are corrected so as to display colors that are as faithful to the input signal regardless of the difference between the color gamut of the image output device such as a display device and the color gamut of the input signal received by the image output device is called “a color gamut conversion process.”

In relation to the present invention, the following related art documents are known. Japanese Patent Application Laid-Open Publication No. 2004-110647 discloses an invention about a method of generating a color conversion coefficient, in which the color conversion coefficient can be determined such that color wash-out or fading do not occur in the color management system. Also, Japanese Patent Application Laid-Open Publication No. 2003-134351 discloses an invention about the spectrum and color reproduction system that performs the color conversion process using an input profile, a display profile, and a color space conversion profile, or the like.

### RELATED ART DOCUMENTS

### Patent Documents

Patent Document 1: Japanese Patent Application Laid-Open Publication No. 2004-110647

Patent Document 2: Japanese Patent Application Laid-Open Publication No. 2003-134351

### SUMMARY OF THE INVENTION

### Problems to be Solved by the Invention

In recent years, so-called online shopping using personal computers, television devices, mobile devices, or the like is popular. However, colors perceived through the screen by the purchaser of a commercial product at the time of ordering can differ from the color of the actual commercial product. This has been a source of trouble between the supplier and the purchaser of the commercial product. Furthermore, the demand for faithful color reproduction is high for display devices used in the medical field (particularly display devices used in the support system or the like for surgeries that require high technology).

The following two points can be raised as causes of the difference between the color perceived through the screen by the purchaser of a commercial product at the time of ordering and the color of the actual commercial product. First, displaying a subject in a sharp manner was considered more important than reproducing the color of the subject faithfully in the image and video processing in digital cameras and television devices because the color reproduction capability of conventional display devices was low. Second, the color gamut of the display content is beyond the display capability (color reproduction capability) of display devices. This problem will be explained with reference to FIG. 14. FIG. 14 is an xy chromaticity diagram of CIE 1931. FIG. 14 shows the range of color perceivable by the human eye with the dotted line indicated by reference character 91, the NTSC color gamut with the thick line indicated by reference character 92, and the sRGB color gamut with the solid line indicated by reference character 93. The NTSC color gamut is represented by the triangle having vertices a1, b1, and c1. The sRGB color gamut is represented by the triangle having vertices a2, b2, and c2. As described above, the NTSC ratio is used as an indicator that expresses the color reproduction capability of a display device, and the NTSC ratio of the sRGB standard is 71 percent. In other words, the NTSC color gamut is broader than the sRGB color gamut. However, as shown in FIG. 14, the chromaticity coordinates of the vertex c2 is outside the NTSC color gamut. Thus, when a display device that has the same color gamut as the NTSC color gamut receives a signal based on the sRGB standard as the input signal, the display device cannot perfectly reproduce the original color based on the input signal.

According to the method of generating a color conversion coefficient described in Japanese Patent Application Laid-Open Publication No. 2004-110647, when there is color data beyond the color gamut of a display device, a linear compression will be performed such that the color data are included within the color gamut of the display device. In other words, colors are merely displayed so as not to give the viewer a sense of discomfort, and not to faithfully reproduce the colors. Similarly, the spectrum and color reproduction system described in Japanese Patent Application Laid-Open Publication No. 2003-134351 does not reproduce colors faithfully.

The present invention aims to provide a liquid crystal display device that can reproduce colors faithfully. In addition, the present invention aims to provide a liquid crystal display device that can indicate to the user whether colors are being reproduced faithfully in order to avoid misunderstanding about the displayed colors.

### Means for Solving the Problems

A first aspect of the present invention is a liquid crystal display device, including: a liquid crystal panel for displaying a color image based on an input signal; and a color gamut conversion unit that converts data values of respective colors included in the input signal in accordance with a color gamut of the input signal and a color gamut of the liquid crystal panel so as to generate an image signal for display to be provided to the liquid crystal panel, wherein, only when the color gamut of the input signal is included within the color gamut of the liquid crystal panel, colors represented by the input signal are faithfully reproduced on the liquid crystal panel by providing the image signal for display generated by the color gamut conversion unit to the liquid crystal panel.

A second aspect of the present invention is the first aspect of the present invention, further including: a color gamut determination unit that determines whether the color gamut of the input signal is included within the color gamut of the liquid crystal panel and provides a determination signal indicating a result of the determination to the liquid crystal panel, wherein the liquid crystal panel displays, in accordance with the determination signal, information indicating whether the colors represented by the input signal are being reproduced faithfully.

A third aspect of the present invention is the second aspect of the present invention, wherein, when chromaticity coordinates of all of three primary colors that specify the color gamut of the input signal are inside a triangle that represents the color gamut of the liquid crystal panel, the color gamut determination unit determines that the color gamut of the input signal is included within the color gamut of the liquid crystal panel.

A fourth aspect of the present invention is the third aspect of the present invention, wherein, when the chromaticity coordinates of the respective primary colors that specify the color gamut of the input signal are defined as primary color chromaticity coordinates, respectively, and when the triangle that represents the color gamut of the liquid crystal panel is defined as a panel color gamut triangle, the color gamut determination unit determines that the primary color chromaticity coordinates are inside the panel color gamut triangle when a line segment that connects coordinates located inside the panel color gamut triangle to the primary color chromaticity coordinates does not intersect with any of three line segments constituting the panel color gamut triangle.

A fifth aspect of the present invention is the forth aspect of the present invention, wherein, when a line segment that connects coordinates specified by an average value of x coordinates and an average value of y coordinates with respect to the chromaticity coordinates of the three primary colors that specify the color gamut of the liquid crystal panel to the primary color chromaticity coordinates does not intersect with any of the three line segments constituting the panel color gamut triangle, the color gamut determination unit determines that the primary color chromaticity coordinates are inside the panel color gamut triangle.

A sixth aspect of the present invention is the first aspect of the present invention or the second aspect of the present invention, further including: a coefficient calculation unit that calculates a conversion coefficient to be used by the color gamut conversion unit when converting the data values of colors included in the input signal, in accordance with chromaticity coordinates of three primary colors that specify the color gamut of the input signal and chromaticity coordinates of three primary colors that specify the color gamut of the liquid crystal panel.

A seventh aspect of the present invention is the sixth aspect of the present invention, wherein the input signal and the image signal for display are data in an RGB color system, wherein a relationship between the input signal and the image signal for display is represented by formula (A) below where T is the conversion coefficient, and wherein the coefficient calculation unit calculates the conversion coefficient T using formula (D) below based on formulas (B) and (C) below, where (B) converts tristimulus RGB values of the input signal into tristimulus XYZ values of data in an XYZ color system in accordance with the color gamut of the input signal, and (C) converts tristimulus RGB values of the image signal for display into the tristimulus XYZ values of the data in the XYZ color system in accordance with the color gamut of the liquid crystal panel:

$$\begin{matrix}〈 Math 1 〉 & \\ {( \begin{matrix}R \\ G \\ B\end{matrix} )}_{D} = T \times {( \begin{matrix}R \\ G \\ B\end{matrix} )}_{S} , & ( A ) \\ 〈 Math 2 〉 & \\ ( \begin{matrix}X \\ Y \\ Z\end{matrix} ) = {( \begin{matrix}{X}_{R} & {X}_{G} & {X}_{B} \\ {Y}_{R} & {Y}_{G} & {Y}_{B} \\ {Z}_{R} & {Z}_{G} & {Z}_{B}\end{matrix} )}_{S} {( \begin{matrix}R \\ G \\ B\end{matrix} )}_{S} , & ( B ) \\ 〈 Math 3 〉 & \\ ( \begin{matrix}X \\ Y \\ Z\end{matrix} ) = {( \begin{matrix}{X}_{R} & {X}_{G} & {X}_{B} \\ {Y}_{R} & {Y}_{G} & {Y}_{B} \\ {Z}_{R} & {Z}_{G} & {Z}_{B}\end{matrix} )}_{D} {( \begin{matrix}R \\ G \\ B\end{matrix} )}_{D} , and & ( C ) \\ 〈 Math 4 〉 & \\ T = {( \begin{matrix}{X}_{R} & {X}_{G} & {X}_{B} \\ {Y}_{R} & {Y}_{G} & {Y}_{B} \\ {Z}_{R} & {Z}_{G} & {Z}_{B}\end{matrix} )}_{D}^{- 1} {( \begin{matrix}{X}_{R} & {X}_{G} & {X}_{B} \\ {Y}_{R} & {Y}_{G} & {Y}_{B} \\ {Z}_{R} & {Z}_{G} & {Z}_{B}\end{matrix} )}_{S} . & ( D )\end{matrix}$$

An eighth aspect of the present invention is the first aspect of the present invention, further including: a gamma correction unit that performs gamma correction on the image signal for display.

A ninth aspect of the present invention is the eighth aspect of the present invention, further including: a de-gamma correction unit that performs de-gamma correction on the input signal.

A tenth aspect of the present invention is the first aspect of the present invention, further including: a conversion coefficient retaining unit that retains in advance a conversion coefficient for each type of the input signal that is for the color gamut conversion unit to use when converting the data values of respective colors included in the input signal, wherein the color gamut conversion unit uses the conversion coefficient that corresponds to the type of the input signal, retained in the conversion coefficient retaining unit, so as to convert the data values of respective colors included in the input signal.

An eleventh aspect of the present invention is the first aspect of the present invention, further including: a display mode selection unit that is used to externally select one of a plurality of display modes including a faithful display mode for faithfully reproducing the colors represented by the input signal on the liquid crystal panel, wherein, when the faithful display mode is selected in the display mode selection unit, the image signal for display generated by the color gamut conversion unit is sent to the liquid crystal panel.

A twelfth aspect of the present invention is the eleventh aspect of the present invention, wherein, when the color gamut of the input signal is not entirely included within the color gamut of the liquid crystal panel when the faithful display mode is selected in the display mode selection unit, information indicating that the colors represented by the input signal are not being reproduced faithfully is displayed on the liquid crystal panel.

A thirteenth aspect of the present invention is the eleventh aspect of the present invention, wherein, only when the faithful display mode is selected in the display mode selection unit, information indicating whether the colors represented by the input signal are being reproduced faithfully is displayed on the liquid crystal panel.

A fourteenth aspect of the present invention is the first aspect of the invention, wherein the color gamut of the liquid crystal panel includes a standard Red-Green-Blue color gamut.

A fifteenth aspect of the present invention is a method of image display in a liquid crystal display device that includes a liquid crystal panel used to display a color image based on an input signal, including: a color gamut conversion step of converting data values of respective colors included in the input signal in accordance with a color gamut of the input signal and a color gamut of the liquid crystal panel so as to generate an image signal for display to be provided to the liquid crystal panel; and a display step of displaying the color image on the liquid crystal panel, wherein, in the display step, only when the color gamut of the input signal is included within the color gamut of the liquid crystal panel, colors represented by the input signal are faithfully reproduced on the liquid crystal panel by providing the image signal for display generated in the color gamut conversion step to the liquid crystal panel.

### Effects of the Invention

According to the first aspect of the present invention, a color gamut conversion unit that converts the data values of respective colors included in an input signal on the basis of the color gamut of the input signal and the color gamut of the liquid crystal panel is provided. Thus, as long as the color gamut of the input signal is included within the color gamut of the liquid crystal panel, it becomes possible to faithfully reproduce colors expressed by the input signal.

According to the second aspect of the present invention, the user can recognize whether the color is being reproduced faithfully. This feature avoids misunderstanding by the user about the color being displayed on the liquid crystal panel. When a commercial product is purchased online, this feature can prevent trouble due to the difference between the color perceived through the screen by the purchaser of the commercial product at the time of ordering and the color of the actual commercial product, for example.

According to the third aspect of the present invention, it becomes possible to reliably determine whether the colors expressed by the input signal can be reproduced faithfully on the liquid crystal panel.

According to the fourth aspect of the present invention, in a manner similar to the third aspect of the present invention, it becomes possible to reliably determine whether the colors expressed by the input signal can be reproduced faithfully on the liquid crystal panel.

According to the fifth aspect of the present invention, in a manner similar to the third aspect of the present invention, it becomes possible to reliably determine whether the colors expressed by the input signal can be reproduced faithfully on the liquid crystal panel.

According to the sixth aspect of the present invention, a conversion coefficient for the color gamut conversion process is calculated in accordance with the color gamut of the input signal. Thus, as long as the color gamut of the input signal is included within the color gamut of the liquid crystal panel, it becomes possible to faithfully reproduce the colors expressed by the input signal in accordance with the input signal having an arbitrary color gamut.

According to the seventh aspect of the present invention, a conversion coefficient for the color gamut conversion process is calculated by taking into account the color gamut of the input signal and the color gamut of the liquid crystal panel and in accordance with the predetermined formula. Thus, as long as the color gamut of the input signal is included within the color gamut of the liquid crystal panel, it becomes possible to faithfully reproduce the colors expressed by the input signal.

According to the eighth aspect of the present invention, the same effects as the first aspect of the present invention can be achieved by performing gamma correction on the image signal for display even when the relationship, held by the liquid crystal panel, between the gradation level of the image signal for display (input signal to the liquid crystal panel) and the display brightness is non-linear.

According to the ninth aspect of the present invention, the same effects as the first aspect of the present invention can be achieved by performing de-gamma correction on the input signal and a gamma correction on the image signal for display even when the input signal has been gamma corrected, and the relationship, held by the liquid crystal panel, between the gradation level of the image signal for display (input signal to the liquid crystal panel) and the display brightness is non-linear.

According to the tenth aspect of the present invention, the liquid crystal display device includes a color gamut conversion unit for retaining the conversion coefficient for a color gamut conversion process. For this reason, there is no need to provide constituting components for calculating the conversion coefficient in the liquid crystal display device. Thus, it becomes possible to implement a liquid crystal display device that can faithfully reproduce colors at low cost.

According to the eleventh aspect of the present invention, it becomes possible for the user to choose whether to reproduce colors faithfully.

According to the twelfth aspect of the present invention, in a manner similar to the second aspect of the present invention, misunderstanding by the user about the color being displayed on the liquid crystal panel is avoided.

According to the thirteenth aspect of the present invention, the display of information unnecessary for the user on the liquid crystal panel is avoided.

According to the fourteenth aspect of the present invention, as long as the input signal is based on the sRGB standard, it becomes possible to reproduce colors expressed by the input signal on the liquid crystal panel.

According to the fifteenth aspect of the present invention, an image display method of the liquid crystal display device can exhibit the same effects as the first aspect of the present invention.

### BRIEF DESCRIPTION OF THE DRAWINGS

FIG. 1 is a block diagram showing an overall configuration of a liquid crystal display device according to Embodiment 1 of the present invention.

FIG. 2 is an xy chromaticity diagram for describing the relationship between the color gamut of a liquid crystal panel and the sRGB color gamut.

FIG. 3 is a view for describing a color gamut determination process in Embodiment 1 described above.

FIG. 4 is an xy chromaticity diagram for describing the color gamut determination process in Embodiment 1 described above.

FIG. 5 is a table showing the chromaticity coordinates of the three primary colors and the white point for the sRGB color gamut, the NTSC color gamut, and the color gamut of the liquid crystal panel (one example), respectively.

FIG. 6 is a view for describing a matrix notation in Embodiment 1 described above.

FIG. 7 is a view for describing a matrix notation in Embodiment 1 described above.

FIG. 8 is a view for describing the flow of the color gamut conversion process in Embodiment 1 described above.

FIG. 9 is a view showing one example of the display of text information conveying that colors are being reproduced faithfully.

FIG. 10 is a view showing one example of the display of text information conveying that colors are not being reproduced faithfully.

FIG. 11 is a view for describing the flow of a color gamut conversion process in Embodiment 2 of the present invention.

FIG. 12 is a view for describing the flow of a color gamut conversion process in a modification example of Embodiment 2 described above.

FIG. 13 is a block diagram showing an overall configuration of a liquid crystal display device according to Embodiment 3 of the present invention.

FIG. 14 is an xy chromaticity diagram for describing the relationship between the sRGB color gamut and the NTSC color gamut in a conventional example.

### DETAILED DESCRIPTION OF EMBODIMENTS

Below, embodiments of the present invention will be explained with reference to the appended figures.

### 1. Embodiment 1

### 1.1 Overall Configuration

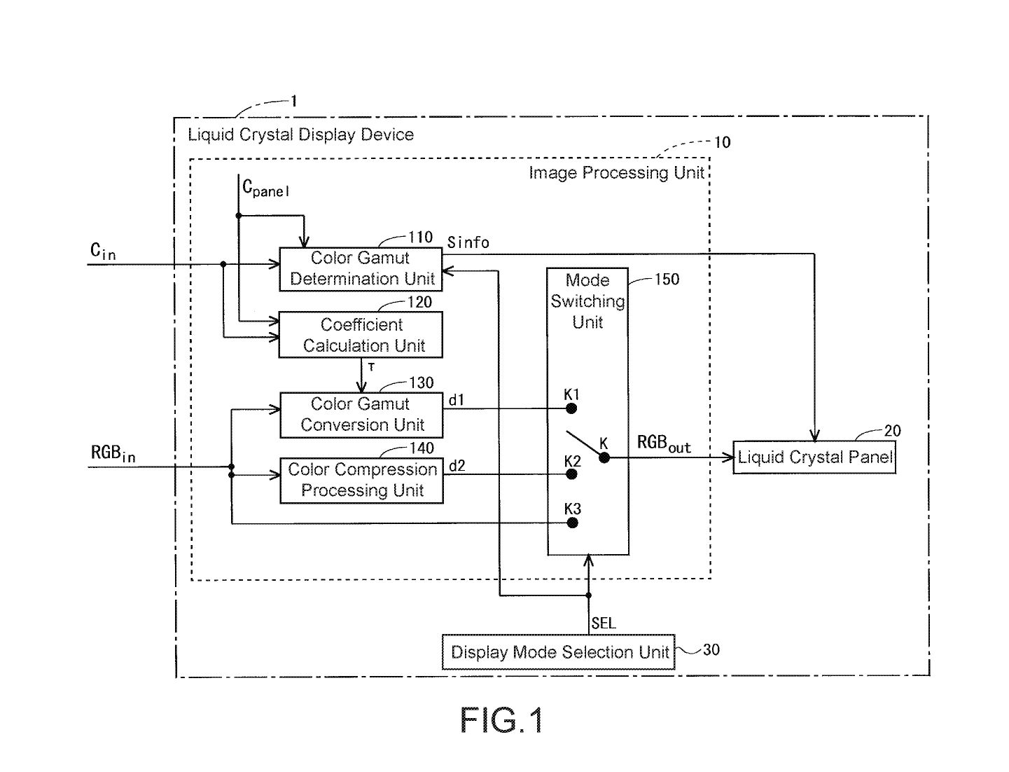

FIG. 1 is a block diagram showing an overall configuration of a liquid crystal display device 1 of Embodiment 1 of the present invention. As shown in FIG. 1, the liquid crystal display device 1 includes an image processing unit 10, a liquid crystal panel 20, and a display mode selection unit 30. The display mode selection unit 30 may be provided outside the liquid crystal display device 1. The image processing unit 10 receives an input RGB signal RGBᵢₙ (input signal) supplied from outside the liquid crystal display device and outputs an RGB signal for the liquid crystal panel RGBₒᵤₜ (image signal for display). In other words, the image processing unit 10 performs a process that converts the input RGB signal RGBᵢₙ into the RGB signal for the liquid crystal panel RGBₒᵤₜ. The conversion is performed in accordance with Cᵢₙ, which is the chromaticity coordinates of the three primary colors according to the standard used by the input RGB signal RGBᵢₙ, and the display mode selection signal SEL provided by the display mode selection unit 30. The image processing unit 10 provides a signal for text information Sinfo (described later) to the liquid crystal panel 20. The display mode selection unit 30 receives a display mode selection made by the user and provides the display mode selection signal SEL that indicates the display mode selected by the user to the image processing unit 10. The liquid crystal panel 20 receives the RGB signal for the liquid crystal panel RGBₒᵤₜ outputted from the image processing unit 10 and displays a color image based on the RGB signal for the liquid crystal panel RGBₒᵤₜ. The liquid crystal panel 20 receives the signal for text information Sinfo outputted from the image processing unit 10 and displays text information based on the signal for text information Sinfo. In the present embodiment, the determination signal is implemented by the signal for text information Sinfo.

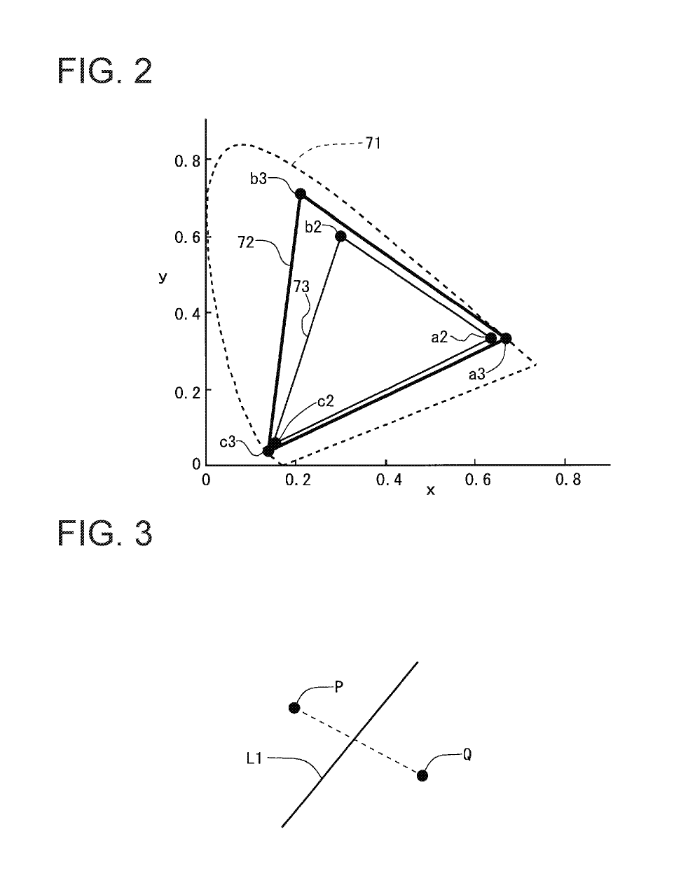

FIG. 2 is an xy chromaticity diagram for describing the relationship between the color gamut of the liquid crystal panel 20 and the sRGB color gamut according to the present embodiment. FIG. 2 shows the range of colors perceivable by the human eye with the curve indicated by reference character 71, the color gamut of the liquid crystal panel 20 according to the present embodiment with the triangle indicated by reference character 72, and the sRGB color gamut with the triangle indicated by reference character 73 (the triangle having vertices a2, b2, and c2). As shown in FIG. 2, all the vertices a2, b2, and c2 of the triangle that represents the sRGB color gamut are inside the triangle that represents the color gamut of the liquid crystal panel 20. In other words, the color gamut of the liquid crystal panel 20 according to the present embodiment completely includes the sRGB color gamut. Thus, as long as the input RGB signal RGBᵢₙ is a signal based on the sRGB standard, the liquid crystal panel 20 according to the present embodiment can faithfully reproduce colors expressed by the input RGB signal RGBᵢₙ.

### 1.2 Configuration of Image Processing Unit

As shown in FIG. 1, the image processing unit 10 includes a color gamut determination unit 110, a coefficient calculation unit 120, a color gamut conversion unit 130, a color compression processing unit 140, and a mode switching unit 150. The color gamut determination unit 110 determines whether the color gamut of the input RGB signal RGBᵢₙ is entirely included within the color gamut of the liquid crystal panel 20 in accordance with Cᵢₙ, which is the chromaticity coordinates of the three primary colors according to the standard used by the input RGB signal RGBᵢₙ, and Cₚₐₙₑₗ, which is the chromaticity coordinates of the three primary colors of the liquid crystal panel 20. In other words, the color gamut determination unit 110 determines whether the liquid crystal panel 20 can faithfully reproduce colors based on the input RGB signal RGBᵢₙ. The process performed by the color gamut determination unit 110 is referred to as “the color gamut determination process” below.

The color gamut determination unit 110 provides the signal for text information Sinfo to the liquid crystal panel 20 in accordance with the result of the determination and the display mode selection signal SEL provided by the display mode selection unit 30. In particular, when the display mode selection signal SEL is indicating “faithful display mode” (described later), and when the result of the determination is that the color gamut of the input RGB signal RGBᵢₙ is entirely included within the color gamut of the liquid crystal panel 20, the color gamut determination unit 110 provides to the liquid crystal panel 20 the signal for text information Sinfo for displaying text information indicating that the color is being reproduced faithfully. When the display mode selection signal SEL is indicating “faithful display mode” and the result of the determination is that the color gamut of the input RGB signal RGBᵢₙ is not entirely included within the color gamut of the liquid crystal panel 20, the color gamut determination unit 110 provides to the liquid crystal panel 20 the signal for text information Sinfo for displaying text information that shows that the color is not being reproduced faithfully. When the display mode selection signal SEL is indicating a display mode other than “faithful display mode,” the liquid crystal panel 20 receives a signal for text information Sinfo that instructs the liquid crystal panel not to display text information such as those described above.

The coefficient calculation unit 120 calculates, in accordance with Cᵢₙ, which is the chromaticity coordinates of the three primary colors according to the standard used by the input RGB signal RGBᵢₙ, and Cₚₐₙₑₗ, which is the chromaticity coordinates of the three primary colors according to the liquid crystal panel 20, a conversion coefficient T that is used in the color gamut conversion process performed by the color gamut conversion unit 130. The detailed description of the color gamut conversion process and the calculation of the conversion coefficient T will be provided later. The color gamut conversion unit 130 performs a color gamut conversion process on the input RGB signal RGBᵢₙ using the conversion coefficient T calculated by the coefficient calculation unit 120. The color compression processing unit 140 performs a process that compresses the gradation value of the input RGB signal RGBᵢₙ so that a color that does not give the viewer a sense of discomfort will be displayed when the color gamut of the input RGB signal RGBᵢₙ is broader than the color gamut of the liquid crystal panel 20. Below, the signal outputted from the color gamut conversion unit 130 is referred to as an internal signal d1, and the signal outputted by the color compression processing unit 140 is referred to as an internal signal d2.

The mode switching unit 150 switches the signal provided to the liquid crystal panel 20 as the RGB signal for the liquid crystal panel RGBₒᵤₜ in accordance with the display mode selection signal SEL provided by the display mode selection unit 30. In the present embodiment, three display modes, “faithful display mode,” “color compression display mode,” and “unmanipulated display mode” are provided. The faithful display mode is a mode used to faithfully reproduce colors expressed by the input RGB signal RGBᵢₙ. The color compression display mode is a mode used to display colors that do not give the viewer a sense of discomfort as much as possible. The unmanipulated display mode is a mode used to perform display by using the gradation values of the input RGB signal RGBᵢₙ, without any change, as the gradation values of the RGB signal for the liquid crystal panel RGBₒᵤₜ. The unmanipulated display mode makes possible a display that takes full advantage of the color reproduction capability of the liquid crystal panel 20 (flashy display, for example) when the color gamut of the input RGB signal RGBᵢₙ is broader than the color gamut of the liquid crystal panel 20.

When the display mode selection signal SEL is indicating “faithful display mode,” a point K and a point K1 become connected in the mode switching unit 150. In this configuration, the internal signal d1 outputted from the color gamut conversion unit 130 is provided to the liquid crystal panel 20 as the RGB signal for the liquid crystal panel RGBₒᵤₜ. When the display mode selection signal SEL is indicating “color compression display mode,” the point K and a point K2 become connected in the mode switching unit 150. In this configuration, the internal signal d2 outputted from the color compression processing unit 140 is provided to the liquid crystal panel 20 as the RGB signal for the liquid crystal panel RGBₒᵤₜ. When the display mode selection signal SEL is indicating “unmanipulated display mode,” the point K and a point K3 become connected in the mode switching unit 150. In this configuration, the input RGB signal RGBᵢₙ is provided to the liquid crystal panel 20, without any change, as the RGB signal for the liquid crystal panel RGBₒᵤₜ.

### 1.3 Color Gamut Determination Process

Next, the color gamut determination process of the present embodiment will be described in detail. In the present embodiment, if all of the Cᵢₙ, which is the chromaticity coordinates of the three primary colors according to the standard used by the input RGB signal RGBᵢₙ, is included within the triangle that represents the color gamut of the liquid crystal panel 20, the color gamut of the input RGB signal RGBᵢₙ will be determined to be included within the color gamut of the liquid crystal panel 20. To perform the determination, for each of Cᵢₙ, which is the chromaticity coordinates of the three primary colors according to the standard used by the input RGB signal RGBᵢₙ, the determination of whether the coordinates are included within the triangle that represents the color gamut of the liquid crystal panel 20 will be carried out as follows.

First, the method used to determine whether a point (referred to as a “point of attention” below) is included within a triangle is described. Let attention be focused on the point of attention P, an arbitrary point Q inside the triangle, and a side L1 of the triangle. If the point of attention P and the point Q are not on the same side of the side L1 used as a reference, then the point of attention P is necessarily outside the triangle (see FIG. 3). As described, when the point of attention P and the point Q are not on a same side of the side L1 used as a reference, the line segment that connects the point of attention P and the point Q intersects with the side L1. Because a triangle is constituted by three sides, if the line segment that connects the point of attention P and the point Q intersects with any one of the three sides that constitute the triangle, then the point of attention P is located outside the triangle. On the other hand, if the line segment that connects the point of attention P and the point Q does not intersect with any of the three sides that constitute the triangle, the point of attention P is located inside the triangle.

In the present embodiment, the coordinates specified by the average value of the x coordinates and the average value of the y coordinates of the three vertices of the triangle that represents the color gamut of the liquid crystal panel 20 (referred to as “the panel color gamut central point” below) will be used as the arbitrary point Q described above. This is because the center of a triangle is necessarily located inside the triangle. A point other than the panel color gamut central point may be used as the arbitrary point Q described above as long as it is a point that is located inside the triangle that represents the color gamut of the liquid crystal panel 20.

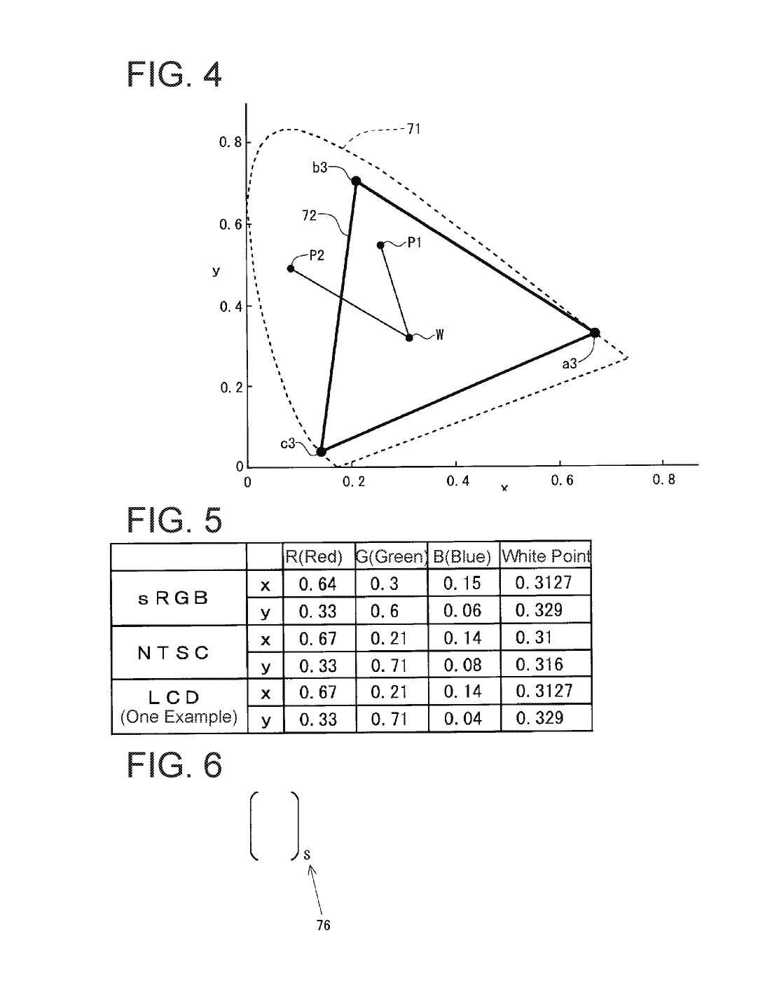

As shown in FIG. 4, when the line segment that connects a panel color gamut central point W and a point P1 does not intersect with any one of the three sides of the triangle that represents the color gamut of the liquid crystal panel 20, the point P1 is located inside the triangle, for example. As shown in FIG. 4, when the line segment that connects the panel color gamut central point W and a point P2 intersects with one of the three sides of the triangle that represents the color gamut of the liquid crystal panel 20, the point P2 is located outside the triangle.

In the present embodiment, for each of Cᵢₙ, which is the chromaticity coordinates of the three primary colors according to the standard used by the input RGB signal RGBᵢₙ, the determination of whether the coordinates are inside the triangle that represents the color gamut of the liquid crystal panel 20 will be carried out in accordance with the way of thinking described above. As described above, when all of Cᵢₙ, which is the chromaticity coordinates of the three primary colors according to the standard used by the input RGB signal RGBᵢₙ, are inside the triangle that represents the color gamut of the liquid crystal panel 20, the color gamut of the input RGB signal RGBᵢₙ will be determined to be included within the color gamut of the liquid crystal panel 20. On the other hand, when at least one of Cᵢₙ, which is the chromaticity coordinates of the three primary colors according to the standard used by the input RGB signal RGBᵢₙ, is located outside the triangle that represents the color gamut of the liquid crystal panel 20, the color gamut of the input RGB signal RGBᵢₙ will be determined not to be included within the color gamut of the liquid crystal panel 20.

From these considerations, when Cᵢₙ, which is the chromaticity coordinates of the respective three primary colors according to the standard used by the input RGB signal RGBᵢₙ, is defined as “primary color chromaticity coordinates,” respectively, and when the triangle that represents the color gamut of the liquid crystal panel 20 is defined as “panel color gamut triangle,” then the following determination will be performed in the color gamut determination process. If a line segment that connects coordinates located inside the panel color gamut triangle to given primary color chromaticity coordinates do not intersect with any one of the three line segments that constitute the panel color gamut triangle, it will be determined that the given primary color chromaticity coordinates are inside the panel color gamut triangle. More particularly, if a line segment that connects the coordinates specified by the average value of x coordinates and the average value of y coordinates with respect to the chromaticity coordinates of the three primary colors that specify the color the color gamut of the liquid crystal panel 20 and given respective primary color chromaticity coordinates do not intersect with any one of the three line segments that constitute the panel color gamut triangle, it will be determined that the given primary color chromaticity coordinates are inside the panel color gamut triangle.

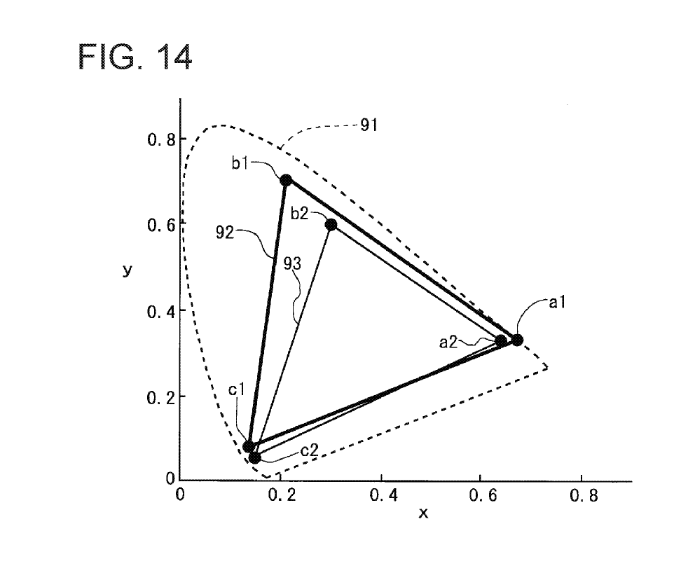

If this color gamut determination process is applied to the example shown in FIG. 14, the point a2 and the point b2 are inside the triangle that represents the NTSC color gamut, but the point c2 is located outside the triangle. Thus, the sRGB color gamut is not entirely included within the NTSC color gamut. In FIG. 2, all the points a2, b2, and c2 are inside the triangle that represents the color gamut of the liquid crystal panel 20. Thus, the sRGB color gamut is entirely included within the color gamut of the liquid crystal panel 20 according to the present embodiment.

FIG. 5 is a table showing the chromaticity coordinates of the three primary colors and the white point for the sRGB color gamut, the NTSC color gamut, and the color gamut of the liquid crystal panel (one example), respectively. In the present embodiment, for ease of description, the chromaticity coordinates of the white point in the sRGB standard and the chromaticity coordinates of the white point for the liquid crystal panel 20 have the same coordinates. The chromaticity coordinates of this white point is necessarily located inside the triangle that represents the color gamut. Thus, the white point of the liquid crystal panel 20 may be used as the arbitrary point Q (described above) that is used in the color gamut determination process.

### 1.4 Color Gamut Conversion Process

Next, the color gamut conversion process of the present embodiment will be described in detail. This section first describes a method of calculating the tristimulus values in the XYZ color system from the tristimulus values in the RGB color system. The RGB color system is a way of representing color that depends on a standard or a device. In contrast, the XYZ color system is a way of representing color that does not depend on a standard or a device. In other words, an RGB value does not represent a color accurately while an XYZ value represents a color that is uniquely determined.

Here, the range of values that the three primary colors RGB can assume is between 0 and 1. The chromaticity coordinates based only on the reference stimulus R are defined as X_{R}, Y_{R}, and Z_{R}, the chromaticity coordinates based only on the reference stimulus G are defined as X_{G}, Y_{G}, and Z_{G}, and the chromaticity coordinates based only on the reference stimulus B are defined as X_{B}, Y_{B}, and Z_{B}. In this regard, the chromaticity coordinates of the X_{R}, Y_{R}, and Z_{R} are invariant with respect to all the RGB stimulus where R≠0, G=0, and B=0, and the XYZ values in the XYZ color system change depending on the value of R. This is the same for the chromaticity coordinates X_{G}, Y_{G}, and Z_{G} and the chromaticity coordinates X_{B}, Y_{B}, and Z_{B}. Below, the XYZ values in the XYZ color system are X_{R}, Y_{R}, and Z_{R}, respectively.

When the stimulus, among the three reference stimuli, is given only from the primary color R at the maximum value thereof, or in other words when R=1, G=0, and B=0, the xyz chromaticity coordinates are expressed by the following formula (1). Also, S_{R}=X_{R}+Y_{R}+Z_{R} holds true.

<Math 5>

x_{R}=X_{R}/S_{R}; y_{R}=Y_{R}/S_{R}; z_{R}=Z_{R}/S_{R} (1)

With respect to an arbitrary R when R≠0, G=0, and B=0 hold true, the X value, the Y value, and the Z value are given by the following formula (2).

<Math 6>

X=RX_{R}; Y=RY_{R}; Z=RZ_{R} (2)

When the stimulus, among the three reference stimuli, is given only from the primary color G at the maximum value thereof, or in other words when R=0, G=1, and B=0, the xyz chromaticity coordinates are expressed by the following formula (3). Also, S_{G}=X_{G}+Y_{G}+Z_{G} holds true.

<Math 7>

x_{G}=X_{G}/S_{G}; y_{G}=Y_{G}/S_{G}; z_{G}=Z_{G}/S_{G} (3)

With respect to an arbitrary G when R=0, G≠0, and B=0 hold true, the X value, the Y value, and the Z value are given by the following formula (4).

<Math 8>

X=GX_{G}; Y=GY_{G}; Z=GZ_{G} (4)

When the stimulus, among the three reference stimuli, is given only from the primary color B at the maximum value thereof, or in other words when R=0, G=0, and B=1, the xyz chromaticity coordinates are expressed by the following formula (5). Also, S_{B}=X_{B}+Y_{B}+Z_{B} holds true.

<Math 9>

x_{B}=X_{B}/S_{B}; y_{B}=Y_{B}/S_{B}; z_{B}=Z_{B}/S_{B} (5)

With respect to an arbitrary B when R=0, G=0, and B≠0 hold true, the X value, the Y value, and the Z value are given by the following formula (6).

<Math 10>

X=BX_{B}; Y=BY_{B}; Z=BZ_{B} (6)

When the three primary colors of RGB are given simultaneously, the values of X, Y, and Z in the XYZ color system are the sums of the individual effect of each of the respective stimuli. Thus, the formula (7) can be derived from the formulas (2), (4), and (6) above.

$$\begin{matrix}〈 Math 11 〉 & \\ \begin{matrix}X = R {X}_{R} + G {X}_{G} + B {X}_{B} \\ Y = R {Y}_{R} + G {Y}_{G} + B {Y}_{B} \\ Z = R {Z}_{R} + G {Z}_{G} + B {Z}_{B}\end{matrix} \} & ( 7 )\end{matrix}$$

The following formula (8) expresses the above formula (7) in a matrix.

$$\begin{matrix}〈 Math 12 〉 & \\ ( \begin{matrix}X \\ Y \\ Z\end{matrix} ) = ( \begin{matrix}{X}_{R} & {X}_{G} & {X}_{B} \\ {Y}_{R} & {Y}_{G} & {Y}_{B} \\ {Z}_{R} & {Z}_{G} & {Z}_{B}\end{matrix} ) ( \begin{matrix}R \\ G \\ B\end{matrix} ) & ( 8 )\end{matrix}$$

The above formula (8) is a conversion formula that computes the tristimulus values in the XYZ color system from the tristimulus values in the RGB color system.

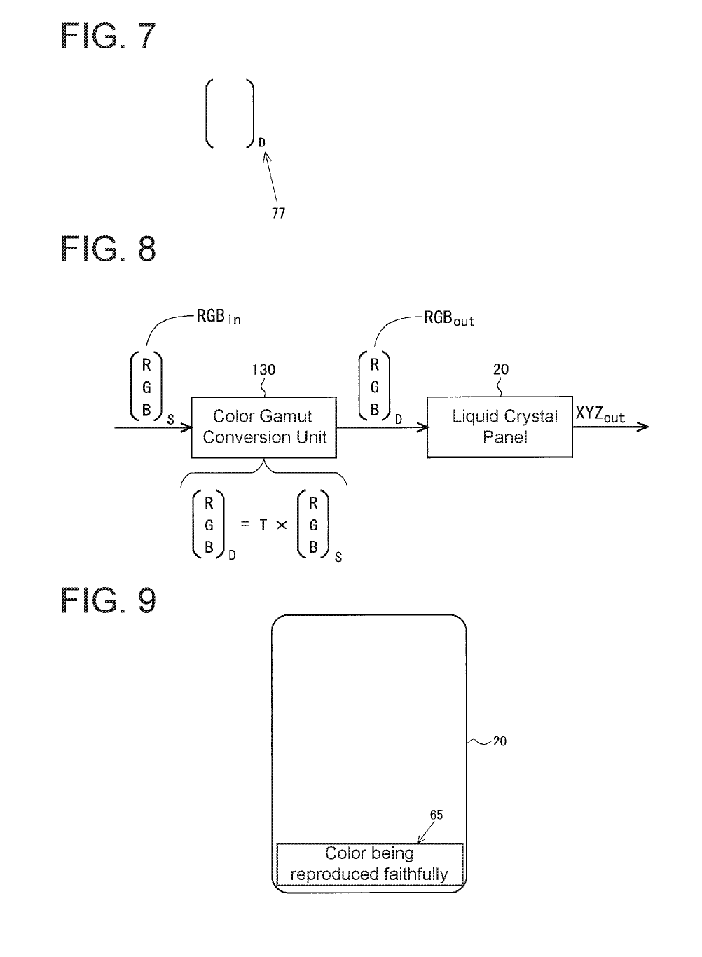

Below, regarding the matrix notation, the letter “S” indicated by the arrow with reference character 76 in FIG. 6 means the input RGB signal RGBᵢₙ, and the letter “D” indicated by the arrow with reference character 77 in FIG. 7 means the liquid crystal panel 20. Using the above formula (8), the XYZ values of the colors that can be reproduced by the input RGB signal RGBᵢₙ can be expressed by the following formula (9). Also, the XYZ values of the colors that can be reproduced by the liquid crystal panel 20 can be expressed by the following formula (10).

$$\begin{matrix}〈 Math 13 〉 & \\ ( \begin{matrix}X \\ Y \\ Z\end{matrix} ) = {( \begin{matrix}{X}_{R} & {X}_{G} & {X}_{B} \\ {Y}_{R} & {Y}_{G} & {Y}_{B} \\ {Z}_{R} & {Z}_{G} & {Z}_{B}\end{matrix} )}_{S} {( \begin{matrix}R \\ G \\ B\end{matrix} )}_{S} & ( 9 ) \\ 〈 Math 14 〉 & \\ ( \begin{matrix}X \\ Y \\ Z\end{matrix} ) = {( \begin{matrix}{X}_{R} & {X}_{G} & {X}_{B} \\ {Y}_{R} & {Y}_{G} & {Y}_{B} \\ {Z}_{R} & {Z}_{G} & {Z}_{B}\end{matrix} )}_{D} {( \begin{matrix}R \\ G \\ B\end{matrix} )}_{D} & ( 10 )\end{matrix}$$

The following formula (11) holds true because the right side of the above formula (9) and the right side of the above formula (10) are equal.

$$\begin{matrix}〈 Math 15 〉 & \\ {( \begin{matrix}R \\ G \\ B\end{matrix} )}_{D} = \underbrace{{( \begin{matrix}{X}_{R} & {X}_{G} & {X}_{B} \\ {Y}_{R} & {Y}_{G} & {Y}_{B} \\ {Z}_{R} & {Z}_{G} & {Z}_{B}\end{matrix} )}_{S} / {( \begin{matrix}{X}_{R} & {X}_{G} & {X}_{B} \\ {Y}_{R} & {Y}_{G} & {Y}_{B} \\ {Z}_{R} & {Z}_{G} & {Z}_{B}\end{matrix} )}_{D}}_{78} \times {( \begin{matrix}R \\ G \\ B\end{matrix} )}_{S} & \end{matrix}$$

Substituting the part indicated by reference character 78 with T, the above formula (11) becomes the following formula (12).

$$\begin{matrix}〈 Math 16 〉 & \\ {( \begin{matrix}R \\ G \\ B\end{matrix} )}_{D} = T \times {( \begin{matrix}R \\ G \\ B\end{matrix} )}_{S} & ( 12 )\end{matrix}$$

T is expressed by the following formula (13).

$$\begin{matrix}〈 Math 17 〉 & \\ T = {( \begin{matrix}{X}_{R} & {X}_{G} & {X}_{B} \\ {Y}_{R} & {Y}_{G} & {Y}_{B} \\ {Z}_{R} & {Z}_{G} & {Z}_{B}\end{matrix} )}_{D}^{- 1} {( \begin{matrix}{X}_{R} & {X}_{G} & {X}_{B} \\ {Y}_{R} & {Y}_{G} & {Y}_{B} \\ {Z}_{R} & {Z}_{G} & {Z}_{B}\end{matrix} )}_{S} & ( 13 )\end{matrix}$$

T in the above formulas (12) and (13) is the conversion coefficient described above.

From above, in the present embodiment, the RGB signal for the liquid crystal panel RGBₒᵤₜ is generated in the color gamut conversion unit 130 using the conversion coefficient T computed by the above formula (13) to convert the data values of each color included in the input RGB signal RGBᵢₙ in accordance with the above formula (12). If the faithful display mode is selected when the color gamut of the input RGB signal RGBᵢₙ is entirely included within the color gamut of the liquid crystal display panel 20, the display device faithfully reproduces the color based on the input RGB signal RGBᵢₙ by performing the color gamut conversion process.

Next, the process performed when a signal based on the sRGB standard is given as the input RGB signal RGBᵢₙ will be described. When the input RGB signal RGBᵢₙ is a signal based on the sRGB standard, the following formula (14) holds true.

$$\begin{matrix}〈 Math 18 〉 & \\ {( \begin{matrix}{X}_{R} & {X}_{G} & {X}_{B} \\ {Y}_{R} & {Y}_{G} & {Y}_{B} \\ {Z}_{R} & {Z}_{G} & {Z}_{B}\end{matrix} )}_{S} = ( \begin{matrix}0.4124 & 0.3576 & 0.1805 \\ 0.2126 & 0.7152 & 0.0722 \\ 0.0193 & 0.1192 & 0.9505\end{matrix} ) & ( 14 )\end{matrix}$$

In addition, regarding the liquid crystal panel 20 according to the present embodiment, it is supposed that the following formula (15) holds true.

$$\begin{matrix}〈 Math 19 〉 & \\ {( \begin{matrix}{X}_{R} & {X}_{G} & {X}_{B} \\ {Y}_{R} & {Y}_{G} & {Y}_{B} \\ {Z}_{R} & {Z}_{G} & {Z}_{B}\end{matrix} )}_{D} = ( \begin{matrix}0.5808 & 0.1965 & 0.1732 \\ 0.2860 & 0.6645 & 0.0495 \\ 0.0000 & 0.0749 & 0.0142\end{matrix} ) & ( 15 )\end{matrix}$$

In this case, from the above formula (13), the conversion coefficient T is expressed by the following formula (16).

$$\begin{matrix}〈 Math 20 〉 & \\ T = ( \begin{matrix}0.5808 & 0.1965 & 0.1732 \\ 0.2860 & 0.6645 & 0.0495 \\ 0.0000 & 0.0749 & 0.0142\end{matrix} ) & ( 16 )\end{matrix}$$

In this way, the RGB signal for the liquid crystal panel RGBₒᵤₜ is generated in the color gamut conversion unit 130 by using the conversion coefficient T expressed by the above formula (16) to convert the data values of each color included in the input RGB signal RGBᵢₙ in accordance with the above formula (12).

The relationships indicated by the following formula (17) hold true between the values x, y, and z and the values X, Y, and Z, and the following formula (18) holds true for the values x, y, and z.

$$\begin{matrix}〈 Math 21 〉 & \\ \begin{matrix}x = \frac{X}{S} \text{:} y = \frac{Y}{S} \text{:} z = \frac{Z}{S} \\ S = X + Y + Z\end{matrix} \} & ( 17 ) \\ 〈 Math 22 〉 & \\ x + y + z = 1 & ( 18 )\end{matrix}$$

In the description above, when deriving each formula, the Y value (brightness) was normalized such that the value is 1 when the R value, the G value, and the B value are all 1. Thus, the following formula (19) expresses the XYZ values of a color that is actually outputted by the liquid crystal panel 20.

$$\begin{matrix}〈 Math 23 〉 & \\ ( \begin{matrix}X \\ Y \\ Z\end{matrix} ) = {L}_{0} \times {( \begin{matrix}{X}_{R} & {X}_{G} & {X}_{B} \\ {Y}_{R} & {Y}_{G} & {Y}_{B} \\ {Z}_{R} & {Z}_{G} & {Z}_{B}\end{matrix} )}_{D} \times T \times {( \begin{matrix}R \\ G \\ B\end{matrix} )}_{S} & ( 19 )\end{matrix}$$

Here, L₀ is the brightness of the liquid crystal panel 20 when the R value, the G value, and the B value are all 1. This brightness is found by measurement.

In the description above, it is supposed that the chromaticity coordinates of the white point of the standard used in the input RGB signal RGBᵢₙ and the chromaticity coordinates of the white point of the liquid crystal panel 20 are the same coordinates. When the chromaticity coordinates of the white points of both coordinates differ, a process that matches the chromaticity coordinates of the white point of the liquid crystal panel 20 with the chromaticity coordinates of the white point of the standard used in the input RGB signal RGBᵢₙ may be performed.

### 1.5 Display of Text Information Based on Color Determination Result

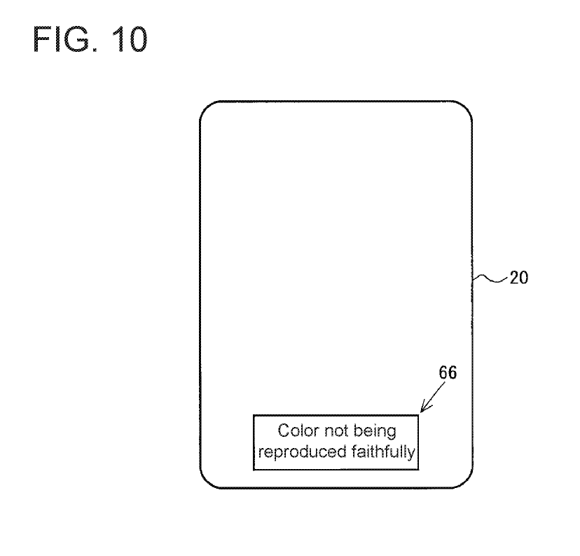

As described above, in the present embodiment, the liquid crystal panel 20 displays text information based on the signal for text information Sinfo outputted by the image processing unit 10. In particular, when the faithful display mode is selected and when the color gamut of the input RGB signal RGBᵢₙ is entirely included within the color gamut of the liquid crystal panel 20, text information indicating that the color is being reproduced faithfully is displayed on the liquid crystal panel 20, as shown in FIG. 9, for example. When the faithful display mode is selected and when the color gamut of the input RGB signal RGBᵢₙ is not entirely included within the color gamut of the liquid crystal panel 20, text information indicating that the color is not being reproduced faithfully is displayed on the liquid crystal panel 20, as shown in FIG. 10, for example. When a display mode other than the faithful display mode is selected, the text information like those described above will not be displayed on the liquid crystal panel 20.

### 1.6 Effects

According to the present embodiment, the image processing unit 10 in the liquid crystal display device 1 includes the color gamut conversion unit 130 that converts the data values of respective colors included in the input RGB signal RGBᵢₙ on the basis of the color gamut of the input RGB signal RGBᵢₙ and the color gamut of the liquid crystal panel 20. When the faithful display mode is selected, a signal generated in the color gamut conversion unit 130 is provided to the liquid crystal panel 20 as the RGB signal for the liquid crystal panel RGBₒᵤₜ. In this configuration, as long as the color gamut of the input RGB signal RGBᵢₙ is included within the color gamut of the liquid crystal panel 20, it becomes possible to faithfully reproduce the colors expressed by the input RGB signal RGBᵢₙ on the liquid crystal panel 20.

Furthermore, in the present embodiment, when the faithful display mode is selected, the liquid crystal panel 20 displays text information indicating whether the color is being reproduced faithfully. This feature avoids misunderstanding by the user about the color being displayed on the liquid crystal panel 20.

From the above, it becomes possible, when a commercial product is purchased online using a liquid crystal panel that has a wide color gamut, to faithfully reproduce the color of the commercial product on the screen, for example. When it is not possible to reproduce the color of the commercial product faithfully, the screen displays text information indicating that the color is not being reproduced faithfully. This feature avoids trouble due to the difference between the color perceived through the screen by the purchaser of the commercial product at the time of ordering and the color of the actual commercial product, for example.

### 2. Embodiment 2

### 2.1 Configuration

The description of Embodiment 1 above was based on the assumption that the relationship held by a liquid crystal panel 20 between the gradation level of the input signal received by the liquid crystal panel 20 (RGB signal for the liquid crystal panel RGBₒᵤₜ) and the display brightness is linear. However, the liquid crystal panel 20 generally has a non-linear characteristic. Accordingly, in the present embodiment, it is supposed that the liquid crystal panel 20 has a non-linear characteristic. Typically, the liquid crystal panel 20 has an output characteristic of gamma 2.2.

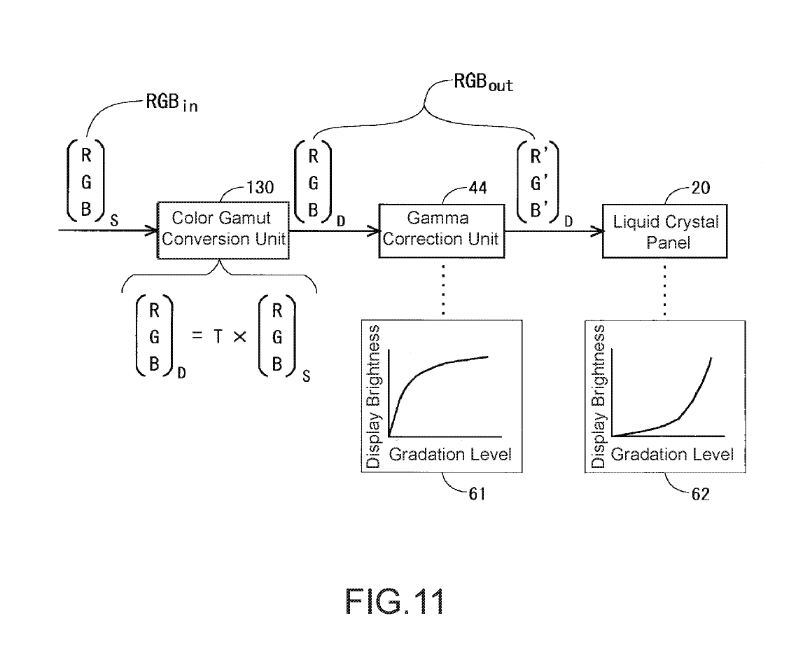

In Embodiment 1 described above, as shown in FIG. 8, a signal generated by the color gamut conversion unit 130 was provided to the liquid crystal panel 20 without any change. In contrast, in the present embodiment, a gamma correction is performed on a signal generated by the color gamut conversion unit 130, and the gamma corrected signal is provided to the liquid crystal panel 20, as shown in FIG. 11. To implement this, the present embodiment includes a gamma correction unit 44 in the step after the color gamut conversion unit 130. When the liquid crystal panel 20 has the output characteristic indicated by reference character 62 in FIG. 11, the gamma correction unit 44 performs gamma correction indicated by reference character 61 in FIG. 11 on the signal generated by the color gamut conversion unit 130, for example. In this way, a gamma correction is performed on the RGB signal for the liquid crystal panel RGBₒᵤₜ according to the present embodiment.

### 2.2 Effects

According to the present embodiment, even when the relationship, held by the liquid crystal panel 20, between the gradation level of the input signal received by the liquid crystal panel 20 (RGB signal for the liquid crystal panel RGBₒᵤₜ) and the display brightness is non-linear, it becomes possible, in a manner similar to Embodiment 1 described above, to faithfully reproduce on the liquid crystal panel 20 the colors expressed by the input RGB signal RGBᵢₙ by performing gamma correction on the RGB signal for the liquid crystal panel RGBₒᵤₜ in the gamma correction unit 44.

### 2.3 Modification Example

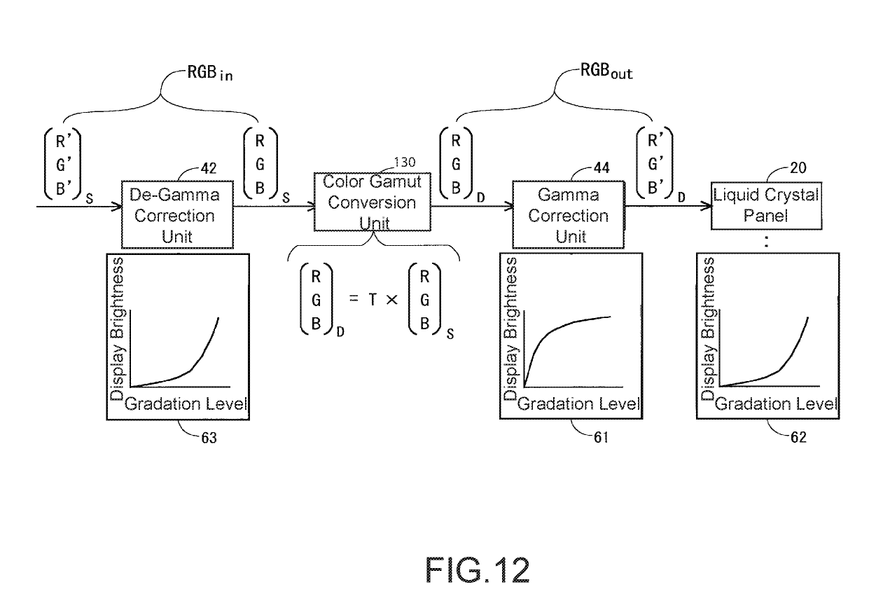

The input signal provided to a liquid crystal display device is generally a gamma corrected signal. Accordingly, the present modification example includes a de-gamma correction unit 42 in a stage before the color gamut conversion unit 130, in addition to the gamma correction unit 44 in a stage after the color gamut conversion unit 130. As shown in FIG. 12, the de-gamma correction unit 42 performs de-gamma correction on the input RGB signal RGBᵢₙ. Then, the de-gamma corrected signal is provided to the color gamut conversion unit 130. In a manner similar to Embodiment 2 described above, the gamma correction unit 44 performs gamma correction on a signal generated by the color gamut conversion unit 130. Then, the gamma corrected signal is provided to the liquid crystal panel 20.

According to the present modification example, even when the input RGB signal RGBᵢₙ is a gamma corrected signal and when the relationship, held by the liquid crystal panel 20, between the gradation level of the input signal received by the liquid crystal panel 20 (RGB signal for the liquid crystal panel RGBₒᵤₜ) and the display brightness is non-linear, it becomes possible, in a manner similar to Embodiment 1 described above, to faithfully reproduce on the liquid crystal panel 20 the colors expressed by the input RGB signal RGBᵢₙ by performing de-gamma correction on the input RGB signal RGBᵢₙ in the de-gamma correction unit 42 and a gamma correction on the RGB signal for the liquid crystal panel RGBₒᵤₜ in the gamma correction unit 44.

### 3. Embodiment 3

### 3.1 Overall Configuration

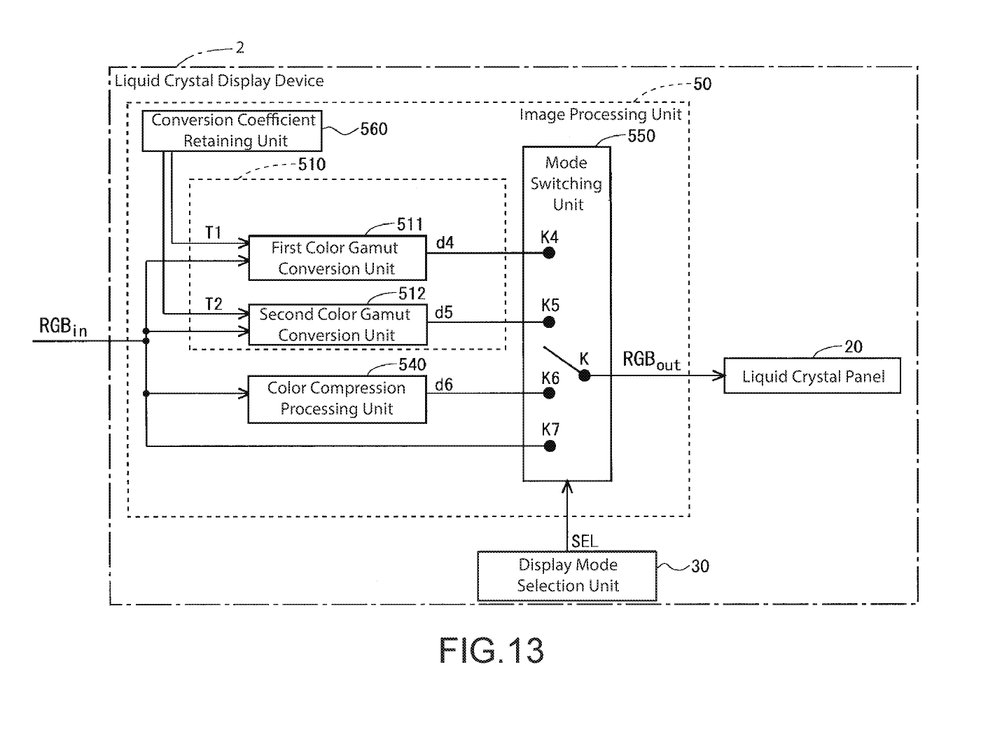

FIG. 13 is a block diagram showing an overall configuration of a liquid crystal display device 2 according to Embodiment 3 of the present invention. As shown in FIG. 13, the liquid crystal display device 2 includes an image processing unit 50, a liquid crystal panel 20, and a display mode selection unit 30. The image processing unit 50 receives an input RGB signal RGBᵢₙ (input signal) supplied from outside the liquid crystal display device and outputs an RGB signal for the liquid crystal panel RGBₒᵤₜ. In other words, the image processing unit 50 performs a process that converts the input RGB signal RGBᵢₙ into the RGB signal for the liquid crystal panel RGBₒᵤₜ. The display mode selection unit 30 receives a display mode selection by the user and provides the display mode selection signal SEL that indicates the display mode selected by the user to the image processing unit 10. The liquid crystal panel 20 receives the RGB signal for the liquid crystal panel RGBₒᵤₜ outputted from the image processing unit 10 and displays a color image based on the RGB signal for the liquid crystal panel RGBₒᵤₜ.

### 3.2 Configuration of Image Processing Unit

As shown in FIG. 13, the image processing unit 50 includes a color gamut conversion unit 510, a color compression processing unit 540, a mode switching unit 550, and a conversion coefficient retaining unit 560. The color gamut conversion unit 510 includes a first color gamut conversion unit 511 and a second color gamut conversion unit 512. The liquid crystal display device 1 according to Embodiment 1 described above was configured so as to be able to faithfully reproduce the color of an input signal having an arbitrary color gamut as long as the color gamut of the input signal does not go beyond the color gamut of the liquid crystal panel 20. In contrast, the liquid crystal display device 2 according to the present embodiment is configured so as to be able to faithfully reproduce colors only with respect to the input signal that has a predetermined color gamut. Thus, unlike Embodiment 1 described above, the image processing unit 50 of the present embodiment does not include a color gamut determination unit or a coefficient calculation unit.

The conversion coefficient retaining unit 560 retains a conversion coefficient T1 that is used in the color gamut conversion process performed by a first color gamut conversion unit 511 and a conversion coefficient T2 that is used in the color conversion process performed by a second color gamut conversion unit 512. The liquid crystal display device 2 of the present embodiment can receive two types of input signals (input RGB signals RGBᵢₙ). Namely, the liquid crystal display device 2 can receive an input signal that has a first color gamut and an input signal that has a second color gamut. Here, the conversion coefficient retaining unit 560 stores in advance the conversion coefficient T1 that is calculated on the basis of the chromaticity coordinates of the three primary colors that specify the first color gamut and the chromaticity coordinates of the three primary colors that specify the color gamut of the liquid crystal panel 20 and the conversion coefficient T2 that is calculated on the basis of the chromaticity coordinates of the three primary colors that specify the second color gamut and the chromaticity coordinates of the three primary colors that specify the color gamut of the liquid crystal panel 20. These conversion coefficients T1 and T2 can be calculated in a manner similar to Embodiment 1 described above. Although the description here is based on the assumption that the liquid crystal display device 2 receives two types of input signals, if the device is provided with as many color gamut conversion units as the number of types of input signals, the liquid crystal display device 2 may receive three or more types of input signals.

The first color gamut conversion unit 511 performs a color gamut conversion process on the input RGB signal RGBᵢₙ that has the first color gamut using the conversion coefficient T1 retained in the conversion coefficient retaining unit 560. The second color gamut conversion unit 512 performs a color gamut conversion process on the input RGB signal RGBᵢₙ that has the second color gamut using the conversion coefficient T2 retained in the conversion coefficient retaining unit 560. The color compression processing unit 540 performs a process that compresses the gradation value with respect to the input RGB signal RGBᵢₙ. Below, a signal outputted from the first color gamut conversion unit 511 is called an internal signal d4, a signal outputted from the second color gamut conversion unit 512 is called an internal signal d5, and a signal outputted from the color compression processing unit 540 is called an internal signal d6.

The mode switching unit 550 switches the signal provided to the liquid crystal panel 20 as the RGB signal for the liquid crystal panel RGBₒᵤₜ in accordance with the display mode selection signal SEL provided by the display mode selection unit 30. In the present embodiment, four display modes, “first faithful display mode,” “second faithful display mode,” “color compression display mode,” and “unmanipulated display mode” are provided. The first faithful display mode and the second faithful display mode are modes used to display colors based on the input RGB signal RGBᵢₙ in a faithful manner. The color compression display mode is a mode used to display colors that do not give the viewer a sense of discomfort as much as possible. The unmanipulated display mode is a mode used to perform display by using the gradation values of the input RGB signal RGBᵢₙ, without any change, as the gradation values of the RGB signal for the liquid crystal panel RGBₒᵤₜ.

When the display mode selection signal SEL is indicating “first faithful display mode,” a point K and a point K4 become connected in the mode switching unit 550. In this configuration, the internal signal d4 outputted from the first color gamut conversion unit 511 is provided to the liquid crystal panel 20 as the RGB signal for the liquid crystal panel RGBₒᵤₜ. When the display mode selection signal SEL is indicating “second faithful display mode,” the point K and a point K5 become connected in the mode switching unit 550. In this configuration, the internal signal d5 outputted from the second color gamut conversion unit 512 is provided to the liquid crystal panel 20 as the RGB signal for the liquid crystal panel RGBₒᵤₜ. When the display mode selection signal SEL is indicating “color compression display mode,” the point K and a point K6 become connected in the mode switching unit 550. In this configuration, the internal signal d6 outputted from the color compression processing unit 540 is provided to the liquid crystal panel 20 as the RGB signal for the liquid crystal panel RGBₒᵤₜ. When the display mode selection signal SEL is indicating “unmanipulated display mode,” the point K and a point K7 become connected in the mode switching unit 550. In this configuration, the input RGB signal RGBᵢₙ is provided to the liquid crystal panel 20, without any change, as the RGB signal for the liquid crystal panel RGBₒᵤₜ.

### 3.3 Effects

According to the present embodiment, the image processing unit 50 in the liquid crystal display device 2 includes the color gamut conversion unit 510 that converts the data values of respective colors included in the input RGB signal RGBᵢₙ on the basis of the color gamut of the input RGB signal RGBᵢₙ and the color gamut of the liquid crystal panel 20. When the faithful display mode (the first faithful display mode or the second faithful display mode) is selected, a signal generated by the color gamut conversion unit 510 is provided to the liquid crystal panel 20 as the RGB signal for the liquid crystal panel RGBₒᵤₜ. This configuration makes it possible to faithfully reproduce on the liquid crystal panel 20 colors expressed by the input RGB signal RGBᵢₙ.

According to the present embodiment, the liquid crystal display device 2 of the present embodiment receives two predetermined types of input signals. For this reason, the image processing unit 50 of the present embodiment differs from Embodiment 1 described above in that the unit does not include a color gamut determination unit or a coefficient calculation unit. Thus, the configuration of the image processing unit 50 becomes simpler than the configuration according to Embodiment 1 described above. Thus, it becomes possible to implement a liquid crystal display device that can faithfully reproduce colors at low cost.

### 4. Other Configurations

The embodiments described above do not limit the present invention, and various modifications can be made without departing from the spirit of the present invention. In Embodiment 1 described above, although the liquid crystal panel 20 displays text information that indicate whether the color is being reproduced faithfully, the liquid crystal panel 20 may display a figure (a mark or the like) instead of text information, for example.

### DESCRIPTION OF REFERENCE CHARACTERS

1, 2 liquid crystal display device
10, 50 image processing unit
20 liquid crystal panel
30 display mode selection unit
42 de-gamma correction unit
44 gamma correction unit
71 range of color perceivable by the human eye
72 color gamut of liquid crystal panel in respective embodiments
73 sRGB color gamut
110 color gamut determination unit
120 coefficient calculating unit
130 color gamut conversion unit
140, 540 color compression processing unit
150, 550 mode switching unit
511 first color gamut conversion unit
512 second color gamut conversion unit
RGBᵢₙ input RGB signal
RGBₒᵤₜ RGB signal for liquid crystal panel
Cᵢₙ chromaticity coordinates of three primary colors in standard of input RGB signal
Cₚₐₙₑₗ chromaticity coordinates of the three primary colors in the liquid crystal panel

1. A liquid crystal display device, comprising:
a liquid crystal panel for displaying a color image based on an input signal; and
a color gamut conversion unit that converts data values of respective colors included in the input signal in accordance with a color gamut of the input signal and a color gamut of the liquid crystal panel so as to generate an image signal for display to be provided to the liquid crystal panel,
wherein, only when the color gamut of the input signal is included within the color gamut of the liquid crystal panel, colors represented by the input signal are faithfully reproduced on the liquid crystal panel by providing the image signal for display generated by the color gamut conversion unit to the liquid crystal panel.

2. The liquid crystal display device according to claim 1, further comprising:
a color gamut determination unit that determines whether the color gamut of the input signal is included within the color gamut of the liquid crystal panel and provides a determination signal indicating a result of the determination to the liquid crystal panel,
wherein the liquid crystal panel displays, in accordance with the determination signal, information indicating whether the colors represented by the input signal are being reproduced faithfully.

3. The liquid crystal display device according to claim 2, wherein, when chromaticity coordinates of all of three primary colors that specify the color gamut of the input signal are inside a triangle that represents the color gamut of the liquid crystal panel, the color gamut determination unit determines that the color gamut of the input signal is included within the color gamut of the liquid crystal panel.

4. The liquid crystal display device according to claim 3, wherein, when the chromaticity coordinates of the respective primary colors that specify the color gamut of the input signal are defined as primary color chromaticity coordinates, respectively, and when the triangle that represents the color gamut of the liquid crystal panel is defined as a panel color gamut triangle, the color gamut determination unit determines, for each of the primary colors, that the primary color chromaticity coordinates are inside the panel color gamut triangle when a line segment that connects a coordinate point located inside the panel color gamut triangle to said primary color chromaticity coordinates does not intersect with any of three line segments constituting the panel color gamut triangle.

5. The liquid crystal display device according to claim 4, wherein, when, for each of the primary colors, a line segment that connects coordinates specified by an average value of x coordinates and an average value of y coordinates with respect to the chromaticity coordinates of the three primary colors that specify the color gamut of the liquid crystal panel to the primary color chromaticity coordinates does not intersect with any of the three line segments constituting the panel color gamut triangle, the color gamut determination unit determines that the primary color chromaticity coordinates are inside the panel color gamut triangle.

6. The liquid crystal display device according to claim 1, further comprising:
a coefficient calculation unit that calculates a conversion coefficient matrix to be used by the color gamut conversion unit when converting the data values of respective colors included in the input signal, in accordance with chromaticity coordinates of three primary colors that specify the color gamut of the input signal and chromaticity coordinates of three primary colors that specify the color gamut of the liquid crystal panel.

7. The liquid crystal display device according to claim 6,
wherein the input signal and the image signal for display are data in an RGB color system,
wherein a relationship between the input signal and the image signal for display is represented by formula (A) below where T is the conversion coefficient matrix, and
wherein the coefficient calculation unit calculates the conversion coefficient matrix T using formula (D) below based on formulas (B) and (C) below, where (B) converts tristimulus RGB values of the input signal represented by
$${( \begin{matrix}R \\ G \\ B\end{matrix} )}_{S}$$
into tristimulus XYZ values of data in an XYZ color system represented by
$$( \begin{matrix}X \\ Y \\ Z\end{matrix} )$$
in accordance with a conversion matrix
$${( \begin{matrix}{X}_{R} & {X}_{G} & {X}_{B} \\ {Y}_{R} & {Y}_{G} & {Y}_{B} \\ {Z}_{R} & {Z}_{G} & {Z}_{B}\end{matrix} )}_{S}$$
that depends on the color gamut of the input signal, and (C) converts tristimulus RGB values of the image signal for display represented by
$${( \begin{matrix}R \\ G \\ B\end{matrix} )}_{D}$$
into the tristimulus XYZ values of the data in the XYZ color system in accordance with a conversion matrix
$${( \begin{matrix}{X}_{R} & {X}_{G} & {X}_{B} \\ {Y}_{R} & {Y}_{G} & {Y}_{B} \\ {Z}_{R} & {Z}_{G} & {Z}_{B}\end{matrix} )}_{D}$$
that depends on the color gamut of the liquid crystal panel:
$$\begin{matrix}〈 Math 24 〉 & \\ {( \begin{matrix}R \\ G \\ B\end{matrix} )}_{D} = T \times {( \begin{matrix}R \\ G \\ B\end{matrix} )}_{S} , & ( A ) \\ 〈 Math 25 〉 & \\ ( \begin{matrix}X \\ Y \\ Z\end{matrix} ) = {( \begin{matrix}{X}_{R} & {X}_{G} & {X}_{B} \\ {Y}_{R} & {Y}_{G} & {Y}_{B} \\ {Z}_{R} & {Z}_{G} & {Z}_{B}\end{matrix} )}_{S} {( \begin{matrix}R \\ G \\ B\end{matrix} )}_{S} , & ( B ) \\ 〈 Math 26 〉 & \\ ( \begin{matrix}X \\ Y \\ Z\end{matrix} ) = {( \begin{matrix}{X}_{R} & {X}_{G} & {X}_{B} \\ {Y}_{R} & {Y}_{G} & {Y}_{B} \\ {Z}_{R} & {Z}_{G} & {Z}_{B}\end{matrix} )}_{D} {( \begin{matrix}R \\ G \\ B\end{matrix} )}_{D} , and & ( C ) \\ 〈 Math 27 〉 & \\ T = {( \begin{matrix}{X}_{R} & {X}_{G} & {X}_{B} \\ {Y}_{R} & {Y}_{G} & {Y}_{B} \\ {Z}_{R} & {Z}_{G} & {Z}_{B}\end{matrix} )}_{D}^{- 1} {( \begin{matrix}{X}_{R} & {X}_{G} & {X}_{B} \\ {Y}_{R} & {Y}_{G} & {Y}_{B} \\ {Z}_{R} & {Z}_{G} & {Z}_{B}\end{matrix} )}_{S} . & ( D )\end{matrix}$$

8. The liquid crystal display device according to claim 1, further comprising:
a gamma correction unit that performs gamma correction on the image signal for display.

9. The liquid crystal display device according to claim 8, further comprising:
a de-gamma correction unit that performs de-gamma correction on the input signal.

10. The liquid crystal display device according to claim 1, further comprising:
a conversion coefficient retaining unit that retains in advance conversion coefficient matrices for various types of the input signal that are for the color gamut conversion unit to use when converting the data values of respective colors included in the input signal,
wherein the color gamut conversion unit uses the conversion coefficient matrix that corresponds to the type of the input signal, among the conversion coefficient matrices retained in the conversion coefficient retaining unit, so as to convert the data values of respective colors included in the input signal.

11. The liquid crystal display device according to claim 1, further comprising:
a display mode selection unit that is used to externally select one of a plurality of display modes including a faithful display mode for faithfully reproducing the colors represented by the input signal on the liquid crystal panel,
wherein, when the faithful display mode is selected in the display mode selection unit, the image signal for display generated by the color gamut conversion unit is sent to the liquid crystal panel.

12. The liquid crystal display device according to claim 11, wherein, when the color gamut of the input signal is not entirely included within the color gamut of the liquid crystal panel when the faithful display mode is selected in the display mode selection unit, information indicating that the colors represented by the input signal are not being reproduced faithfully is displayed on the liquid crystal panel.

13. The liquid crystal display device according to claim 11, wherein, only when the faithful display mode is selected in the display mode selection unit, information indicating whether the colors represented by the input signal are being reproduced faithfully is displayed on the liquid crystal panel.

14. The liquid crystal display device according to claim 1, wherein the color gamut of the liquid crystal panel includes a standard Red-Green-Blue color gamut.

15. A method of image display in a liquid crystal display device that includes a liquid crystal panel used to display a color image based on an input signal, comprising:
a color gamut conversion step of converting data values of respective colors included in the input signal in accordance with a color gamut of the input signal and a color gamut of the liquid crystal panel so as to generate an image signal for display to be provided to the liquid crystal panel; and
a display step of displaying the color image on the liquid crystal panel,
wherein, in the display step, only when the color gamut of the input signal is included within the color gamut of the liquid crystal panel, colors represented by the input signal are faithfully reproduced on the liquid crystal panel by providing the image signal for display generated in the color gamut conversion step to the liquid crystal panel.
